(19) United States
(12) Patent Application Publication
(10) Pub. No.: US 2012/0183270 A1
(43) Pub. Date: Jul. 19, 2012

(54) WEBCAM CAPTCHA

(75) Inventors: Michael L. Greenblatt, Highland, NY (US); Heidi Lagares-Greenblatt, Highland, NY (US)

(73) Assignee: INTERNATIONAL BUSINESS MACHINES CORPORATION, Armonk, NY (US)

(21) Appl. No.: 13/006,624

(22) Filed: Jan. 14, 2011

(51) Int. Cl. H04N 5/225; H04N 5/77

(52) U.S. Cl. 386/224; 348/207.1; 348/E05.024; 386/E05.069

(57) ABSTRACT

A system and computer-implemented method for determining whether a user of a computer system is a human or a computer program that includes determining whether a camera device is connected with the computer system, requesting the user to perform an action and reviewing the recorded image and validating whether the requested action has been performed by the user, based on one or more of a determined level of confidence that the user is a human, and any detected error in the recorded image. The recorded image is accepted or rejected based on policy settings of a service provider in view of the one or more of the determined confidence level and any detected error in the recorded image, wherein accepting the recorded image corresponds to a determination that the user is a human.

### BACKGROUND

The present invention relates to a Completely Automated Public Turing test to tell Computers and Humans Apart (CAPTCHA) program implemented via a computer system. More particular to a computer system and method for capturing and transmitting an image of a user performing a requested action via a camera device and verifying the same.

A CAPTCHA program is implemented in a computer system to determine the difference between humans and a computer program based on their respective abilities to solve a problem. It is commonly used on web pages where a user registers for an account to prevent the use of computer-programmed registrations used for unsolicited bulk messaging (e.g., SPAM).

A typical CAPTCHA program may prompt a user to look at an image and type the alphabetic or numeric characters shown within the image. Further, other CAPTCHAs may request that users recognize and tag images. Some problems associated with these CAPTCHAs are that they are sometimes too challenging and complicated to allow the user to gain access to a website or it may be possible for a computer program to imitate a valid user and gain unauthorized access to the computer system.

### SUMMARY

According to one embodiment of the present invention, a computer-implemented method for determining whether a user of a computer system is a human or a computer program is provided. The method includes determining whether a camera device is connected with the computer system, requesting the user to perform an action and recording an image (still or video) of the user performing an action via the camera device, when it is determined that a camera device is connected with the computer, reviewing the recorded image and validating whether the requested action has been performed by the user, based on one or more of a determined level of confidence that the user is a human and any detected error in the recorded image; and accepting or rejecting the recorded image based on policy settings of a service provider in view of the one or more of the determined confidence level and any detected error in the recorded image; wherein accepting the recorded image corresponds to a determination that the user is a human.

According to other embodiments of the present invention, a computer system and computer-program product capable of performing the above-mentioned method are provided.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating an example of a client/server environment that can be implemented within embodiments of the present invention.

FIG. 2 is a diagram illustrating an example of a computer system at the client side that may be used to implement embodiments of the present invention.

FIG. 3 is a flow diagram illustrating a computer-implemented method for determining whether a user is a human or a computer program via a computer system as shown in FIG. 2.

FIG. 4 is a screenshot illustrating an operation for recording an image of the user that can be implemented within embodiments of the present invention.

### DETAILED DESCRIPTION

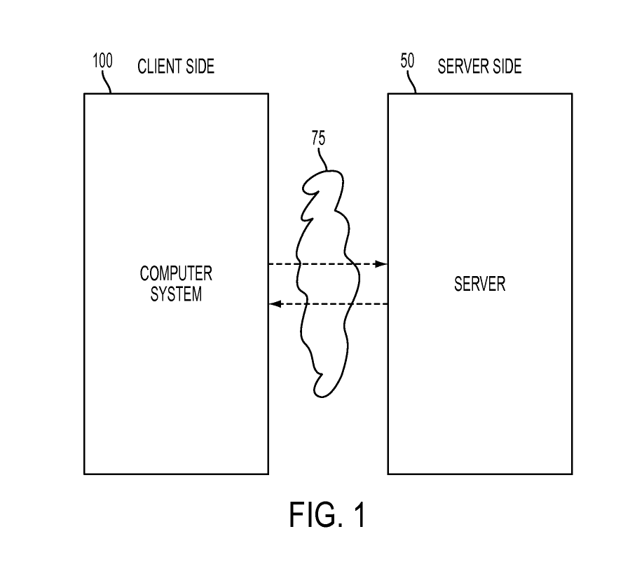

Embodiments of the present invention, involve communication between a client and a server. For example, FIG. 1 is a block diagram illustrating a client/server environment that can be implemented within embodiments of the present invention. As shown in FIG. 1, at least two computers 50 and 100 may be included in the client/server environment. The present invention implements the use of CAPTCHA technology to enable a user to gain access to information at the server side (i.e., at server 50). The computer system 100 at the client side communicates with the server 50 at the server side via a network 75. In one example, the server 50 may be a web server for a bank and the user at the computer system 100 on the client side may be attempting to sign up for a bank account. The computer server 50 utilizes CAPTCHA technology via the computer system 100 to verify the user at the client side.

Some communications from humans to computers are based on keyboard and an input device such as a mouse joystick, control wand, or digital control glove. The present invention introduces the use of image and movement recognition technology to further enhance the communication between humans and computers. Embodiments of the present invention, allow the computer system 100 at the request of the server 50, to validate that a user is human using a camera device and movement and gesture recognition technology. Movement or gesture recognition is a part of Human Machine Interaction. Some examples of the use of this technology are Logitech™ avatar technology and Playstation™ eye technology. The Playstation™ eye allows users bodies to act as their game controller by recording them and then using motion recognition technology to map their movements into the games. The Logitech™ avatar and special effects track a user's gestures and facial movements and then layer effects or make the avatars mimic these movements.

Additionally, referring back to FIG. 1, at the server 50 request, the computer system 100 may prompt the user to perform actions (e.g., gestures) such as smile, frown, look down, look up, touch your nose, etc, to validate that they are a human. The present invention discloses a system and computer-implemented method for capturing an image or movement of a user via a camera device and using gesture and movement recognition technology to verify if a human performed the requested action. Further, the server 50 may implement other types of CAPTCHAs or tests in conjunction with that of the present invention. For example, the server 50 may want to take extra security precaution, so the server 50 may require a user to pass multiple CAPTCHAs before trusting the user in a human.

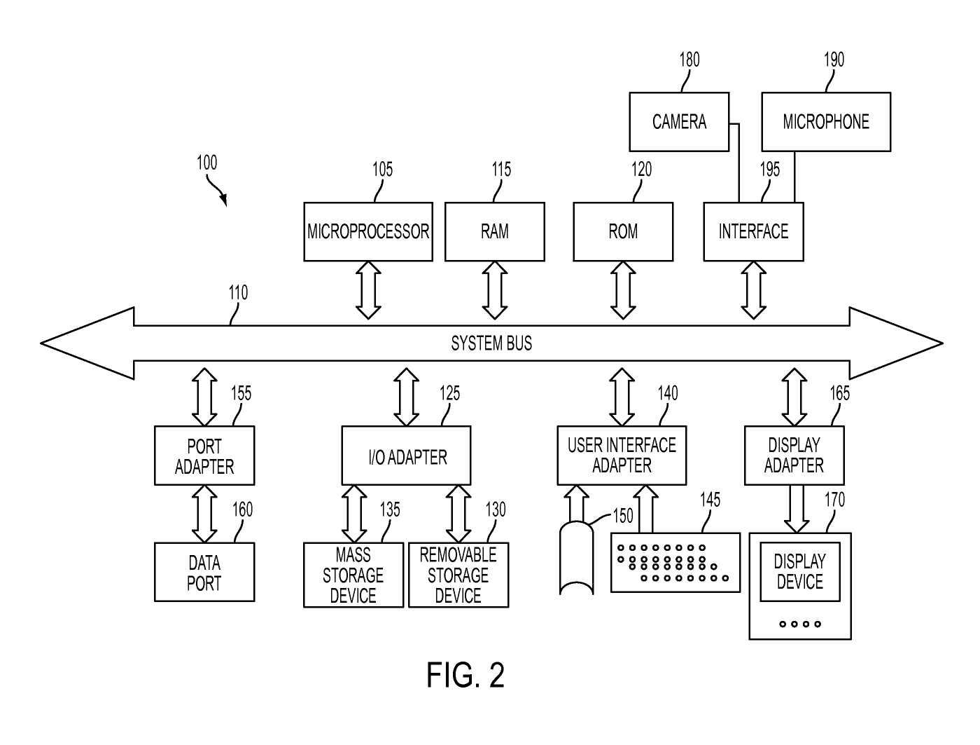

FIG. 2 is a schematic block diagram of a general-purpose computer suitable for practicing the present invention embodiments. In FIG. 2, a computer system 100 is provided. The computer system 100 has at least one microprocessor or central processing unit (CPU) 105. CPU 105 is interconnected via a system bus 110 to a random access memory (RAM) 115, a read-only memory (ROM) 120, an input/output (I/O) adapter 125 for a connecting a removable data and/or program storage device 130 and a mass data and/or program storage device 135, a user interface adapter 140 for connecting a keyboard 145 and a mouse 150, a port adapter 155 for connecting a data port 160 and a display adapter 165 for connecting a display device 170.

ROM 120 contains the basic operating system for computer system 100. The operating system may alternatively reside in RAM 115 or elsewhere as is known in the art. Examples of removable data and/or program storage device 130 include magnetic media such as floppy drives and tape drives and optical media such as CD ROM drives and flash drives. An example of mass data and/or a program storage device 135 includes hard disk drives. In addition to keyboard 145 and mouse 150, other user input devices such as trackballs, writing tablets, pressure pads, microphones, light pens and position-sensing screen displays may be connected to user interface 140. Examples of display devices include cathode-ray tubes (CRTs) and liquid crystal displays (LCDs). For the purposes of the present invention, a camera device 180 and a microphone 190 may be included as input devices to the computer system 100. The camera device 180 and microphone 190 may be built-in to the computer system 100 or external devices connected to the computer system 100 through an interface 195 to the system bus 110 as shown in FIG. 2. The camera device 180 may be a digital electronic still or video camera capable of capturing a plurality of images. These images may be routed to and stored in the RAM 115.

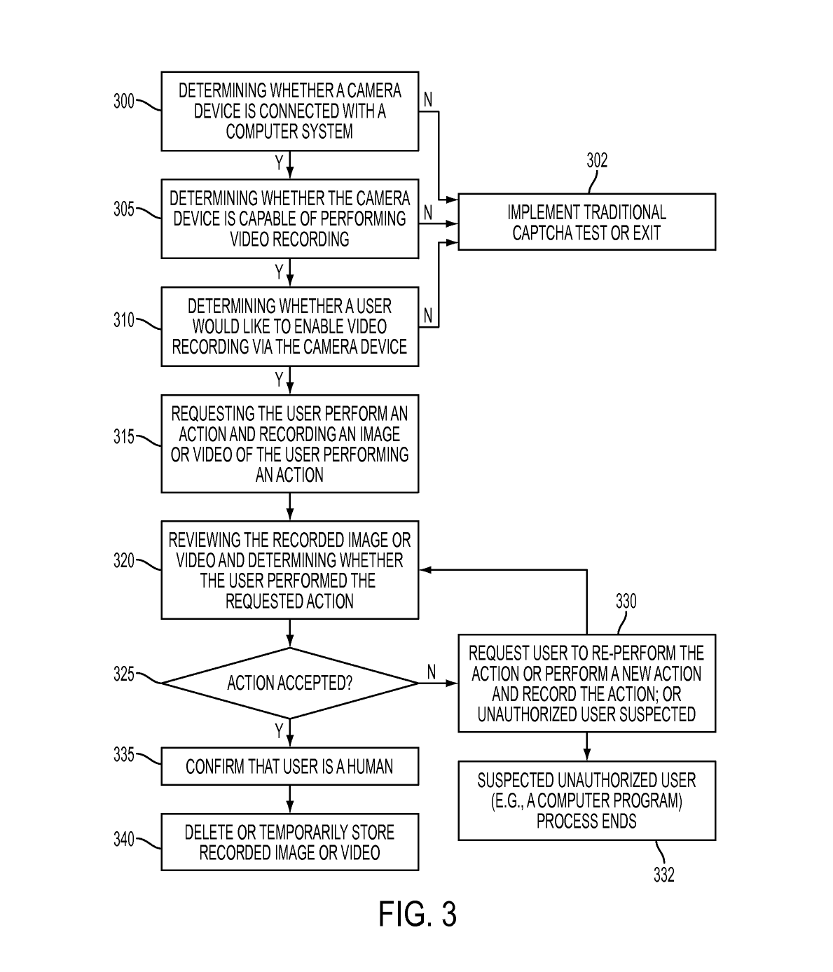

According to an embodiment of the present invention, as mentioned above, the server 50 and the computer system 100 at the client side communicate over a network 75 via web services. According to one embodiment, the computer system 100 may store the user's video or stream it and send it over to the server 50 (i.e., web server) in order to perform the method discussed below with reference to FIG. 3. The action of human recognition and accepting the user as a human may be done at the server 50. Thus, no further verification process may be required at the user's computer system 100. In operation, information for performing the method according to an embodiment of the present invention or the system created to run the present invention is loaded on the appropriate removable data and/or program storage device 130, fed through data port 160 or typed in using keyboard 145.

According to another embodiment of the present invention, a computer program with an appropriate application interface may be created and stored on the system 100 or a data and/or program storage device to perform the method according to embodiments of the present invention as discussed below with reference to FIG. 3

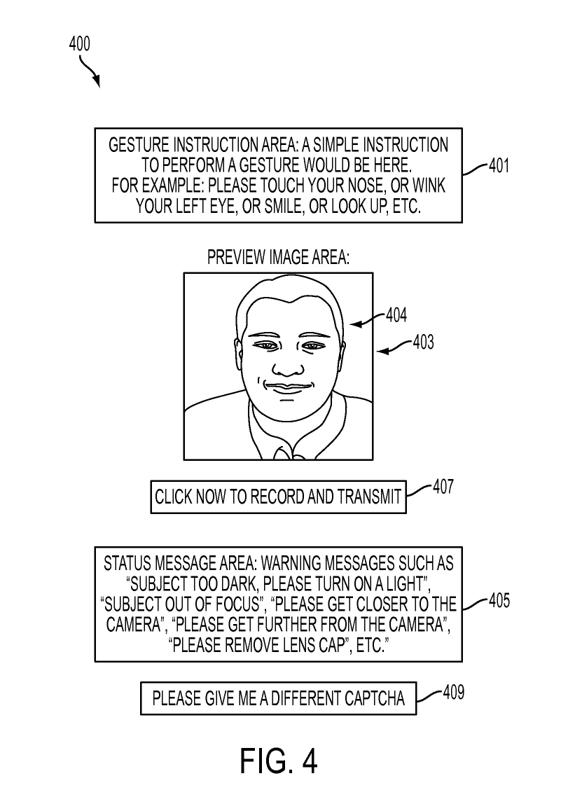

Additional details regarding the system and method for determining whether a user is a human or a computer program will now be discussed below with reference to FIGS. 3 and 4.

FIG. 3 is a flow diagram illustrating a method for determining whether a user is a human or a computer program in accordance with embodiments of the present invention. According to an embodiment of the present invention, the method shown in FIG. 3 may be implemented as a CAPTCHA program at the request of a server 50. As shown in FIG. 3, in operation 300, it is determined whether a camera device 180 is connected with the computer 100. If no such camera device 180 is present, the process proceeds to operation 302, where a traditional CAPTCHA test may be implemented (e.g., such as a text based CAPTCHA test that does not require the use of a camera), or alternatively the process exits at that point.

On the other hand, if a camera device 180 is in fact present, the process moves to operation 305, where it is determined whether the camera device 180 is capable of performing video recording, whether alone or in combination with the client 50 and/or or server 100. If it is determined at operation 305 that the camera device 180 does not have video recording capabilities, the process proceeds to operation 302 as described above. Otherwise, it is determined whether the user would like to enable video recording via the camera device 180 in operation 310. For example, according to an embodiment of the present invention, the user may be prompted by a message such as “Would you allow your webcam to record a short video of you performing a simple gesture in order to confirm that you are a human? This video will not be associated with any of your account data or personal information, and will not be used outside of our user verification system, and will be permanently deleted from all of our systems shortly after verifying that you are a human.” Reply options will also be made available to the user such as “Allow this one time”, “Do not allow at this time”, “Always allow”, or “Never allow”.

If answered in the affirmative, the process will continue to operation 315, where the user will be prompted by the system to perform an action via the camera device 180 in order to prove the user is a human. Any such action performed by the user is recorded via the camera device 180. If answered in the negative, the process will proceed to operation 302 as described above.

FIG. 4 is a screenshot illustrating an operation for recording an image of the user that can be implemented within embodiments of the present invention. As shown in FIG. 4, a user receives instructions via an instruction area 401 of the screenshot 400, requesting the performance of a gesture, for example, “Please touch your nose”, “Please wink your left eye”, or “Please smile”. If the user is providing a video or still image input, the user may preview the image in a similar manner as that of video chat services, for example. A preview of an image 404 to be captured by the camera device 180 is then displayed to the user in a preview image display area 403 via the display device 170. In one embodiment, the camera device 180 may be a web cam that records and stores or streams video. An additional embodiment may be a web cam that captures a still image of the requested gesture. While such an implementation would allow for less data to be stored or transferred, it adds challenges such as timing the snap shot. Moreover, still images would be easier to hack. Still another option would be to use any suitable digital camera to take a picture, although this would arguably be the weakest of all implementations since a hacker could take a picture of each action and keep reusing it.

According to an embodiment of the present invention, the requested action may include at least one gesture to be performed via a face, hand or other body part of the user.

According to an embodiment of the present invention, status information may be provided to the user. The status information may be displayed to the user via a status message area 405 as shown in FIG. 4. According to an embodiment of the present invention, the status message may include warnings regarding the preview of the image 404 such as “Subject too dark, please turn on a light”, “Subject out of focus”, “Please get closer to the camera”, “Please get further from the camera” or “Please remove lens cap”. In addition, the user may receive status alerts concerning an operation state of the camera device 180 such as “Camera not connected”.

According to an embodiment of the present invention, the system 100 may wait to record/transmit any data until the user makes a selection via a selection mechanism (e.g., a button) 407 to do so.

According to an embodiment of the present invention, a selection option 409 may be available to the user for requesting a different type of verification method, for example, a CAPTCHA program that provides for input of alphabet or numeric characters instead of image capturing options. This is to preserve the privacy of users who normally would be fine with having their image recorded, but are currently in an inappropriate or uncomfortable setting.

Filtering operations may also be applied to the recorded image 404 to reduce privacy concerns of the user. Additional images depicting various gestures may be requested to determine if a user is a human, and different types of filtering operations applied to the images may also be implemented within embodiments of the present invention. The filtering of the image may be performed via software of the camera device 180 or via instructions provided by installing a driver.

For example, a user's image may be displayed via the display device 170, with the user being requested to smile. The user's image is captured and filtered in black and white as requested by the user. In another example, the user is requested to touch an ear and the image of the user having performed the requested action is captured and filtered via a different type of filtering operation. Still another example may include the user being requested to put his hand over his chest, or to open his mouth and the image is captured and displayed via the display device 170. Embodiments of the present invention are not limited to any particular type of filtering operation performed on the images however the amount of image obfuscation is limited to avoid interference with the system's ability to recognize images and associated gestures.

Alternatively, instead of capturing an image of the user, the user may be replaced by an avatar image (i.e., a computer user's representation of himself/herself or alter ego in the form of an image). If an avatar is transmitted to the recognition service, it will only be able to recognize whether or not the requested gesture or motion was performed. An optional client side program may be installed at the computer system 100 to recognize if the original unfiltered non-avatar image looked human and send a “yes” or “no” along with the Avatar data to the server 50. Also, the site or service using the CAPTCHA, service according to an embodiment of the present invention, may determine that gesture recognition is sufficient verification by itself that the user is a human.

Referring back to FIG. 3, from operation 315 the process continues to operation 320 where it is validated whether the requested action has been performed. That is, whether the user has properly performed the requested action. This validation may occur at the computer system 100 or the server 50, and may entail analyzing the video/image and determining a level of confidence that the user is a human. In addition, if there is an error, the validation may further determine the nature of the error (e.g., blurry image, poor lighting, incorrect action, non-human appearance, etc.). Next, at operation 325, the user's input is accepted or rejected by the system 100 or server 50. This may entail, for example, checking the policy settings for the particular service (e.g., bank or other web service) employing the CAPTCHA technology to see whether the determined confidence level and/or detected error type if any is satisfactory. If the user's input is rejected at operation 325, the process continues to operation 330 where one of the following operations may occur: a) the user is requested to re-perform the action, b) the user is requested to perform a different action, or c) the system suspects an unauthorized user (e.g., a computer program), in which case the process would end. According to an embodiment of the present invention, the action taken may be determined based on the manner of the error or based on predetermined user or system settings. An example of an error might be the connection was bad and the video was delivered choppy, or the user looked left when the user was prompted to look right, or the image is too dark to be recognizable. The user may be too close, too far, or there may be too much backlighting, etc. The predetermined settings can vary based on how protective a website wants to be versus how easy the server 50 wants to make it for users. There can be varying degrees of certainty whether the proper gesture was performed or whether the user is a human, and settings could be made based on the certainty level. For example, the server 50 may have a predetermined setting of certainty level of 100% or 75%.

Referring back to operation 330, if option a) or b) occurs, the process returns to operation 320 where the validation process is repeated. If the user input is accepted at operation 325, the process continues to operation 335 where it is confirmed that the user is a human. Next, at operation 340, the recorded image may be immediately deleted or stored for a predetermined period of time based on user-defined or system-defined settings to compare to potential unauthorized users (e.g., spammers). This information may be stored at the computer system 100 or the server 50. Alternatively, if option c) is selected at operation 330, the process ends at operation 332 as indicated above.

Embodiments of the present invention provide a system and method for determining whether a computer user is a human or a computer program in order to authenticate the user. Thus, the advantages associated with the present invention include preventing unauthorized access to web pages and unsolicited bulk messaging.

In view of the above, the present method embodiment may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method for determining whether a user of a computer system is a human or a computer program, the method comprising:
determining whether a camera device is connected with the computer system;
requesting the user to perform an action and recording an image of the user performing an action via the camera device, when it is determined that a camera device is connected with the computer system;
reviewing the recorded image and validating whether the requested action has been performed by the user, based on one or more of a determined level of confidence that the user is a human, and any detected error in the recorded image; and
accepting or rejecting the recorded image based on policy settings of a service provider in view of the one or more of the determined confidence level and any detected error in the recorded image;
wherein accepting the recorded image corresponds to a determination that the user is a human.

2. The computer-implemented method of claim 1, wherein determining whether a camera device is connected with the computer system comprises:
determining whether the camera device is capable of performing video recording when it is determined that a camera device is connected with the computer system; and
determining, via the user, whether to enable video recording using the camera device.

3. The computer-implemented method of claim 1, wherein the requested action to be performed comprises at least one gesture to be performed via a face, hand or other body part of the user.

4. The computer-implemented method of claim 1, wherein requesting the user to perform an action comprises:
providing instructions from a server in communication with the computer system, to the user via the computer system, to request performance of the action; and
capturing a preview of an image of the user, and displaying the preview via a display device of the computer system.

5. The computer-implemented method of claim 4, wherein the recorded image is transferred to the server for validation to gain access to information provided at the server.

6. The computer-implemented method of claim 4, further comprising:
providing status information to the user via the display device regarding at least one of the preview of the image and an operation state of the camera.

7. The computer-implemented method of claim 1, further comprising:
providing a selection option to the user, for the user to request a different type of verification method to be used to determine whether the user is a human or a computer program.

8. The computer-implemented method of claim 1, further comprising:
filtering the recorded image, and displaying the filtered recorded image in place of the recorded image.

9. The computer-implemented method of claim 1, wherein accepting or rejecting the recorded image comprises:
requesting that the user re-perform the requested action, requesting that the user perform a different action, or suspecting that the user is a computer program, when the recorded image is rejected.

10. The computer-implemented method of claim 9, further comprising:
immediately deleting or temporarily storing the recorded image for a predetermined time period for use in comparing to potential unauthorized users, based on user-defined or system-defined settings.

11. The computer-implemented method of claim 10, further comprising:
replacing the recorded image with an avatar based upon a request of the user to be displayed in place of the recorded image.

12. A computer system capable of determining whether a user is a human or a computer program, the system comprising:
a computer device;
a computer program comprising program modules executable by the computer device, wherein the computer device is directed by the program modules of the computer program to:
determine whether a camera device is connected with the computer system;
request the user to perform an action and record an image of the user performing an action via the camera device, when it is determined that a camera device is connected with the computer system;
review the recorded image and validate whether the requested action has been performed by the user, based on one or more of a determined level of confidence that the user is a human, and any detected error in the recorded image; and
accept or reject the recorded image based on policy settings of a service provider in view of the one or more of the determined confidence level and any detected error in the recorded image; and
wherein accepting the recorded image corresponds to a determination that the user is a human.

13. The computer system of claim 12, wherein the program module to determine whether a camera device is connected with the computer system comprises modules to:
determine whether the camera device is capable of performing video recording when it is determined that a camera device is connected with the computer system; and
determine, via the user, whether to enable video recording using the camera device.

14. The computer system of claim 12, wherein the requested action to be performed comprises at least one gesture to be performed via a face, hand or other body part of the user.

15. The computer system of claim 12, wherein the program module to request the user to perform an action includes program modules to:
provide instructions from a server in communication with the computer device, to the user via the computer system, to request performance of the action; and
capture a preview of an image of the user, and display the preview via a display device of the computer system.

16. The computer system of claim 15, wherein the recorded image is transferred to the server for validation to gain access to information provided at the server.

17. The computer system of claim 15, further comprising program modules to:
provide status information to the user via the display device regarding at least one of the preview of the image and an operation state of the camera.

18. The computer system of claim 12, further comprising program modules to:
provide a selection option to the user, for the user to request a different type of verification method to be used to determine whether the user is a human or a computer program.

19. The computer system of claim 12, further comprises program modules to:
filter the recorded image, and display the filtered recorded image in place of the recorded image.

20. The computer system of claim 12, wherein the program module to accept or reject the recorded image comprises program modules to:
request that the user re-perform the requested action, request that the user perform a different action, or suspect that the user is a computer program, when the recorded image is rejected.

21. The computer system of claim 20, further comprising program modules to:
immediately delete or temporarily store the recorded image for a predetermined time period for use in comparing to potential unauthorized users, based on user-defined or system-defined settings.

22. A computer-program product comprising a computer useable medium including a computer readable program, wherein the computer readable program when executed on a computer system causes the computer system to implement a method determining whether a user of the computer system is a human or a computer program, the method comprising:
determining whether a camera device is connected with the computer system;
requesting the user to perform an action and recording an image of the user performing an action via the camera device, when it is determined that a camera device is connected with the computer system;
reviewing the recorded image and validating whether the requested action has been performed by the user, based one or more of a determined level of confidence that the user is a human and any detected error in the recorded image; and
accepting or rejecting the recorded image based on policy settings of a service provider in view of the one or more of the determined confidence level and any detected error in the recorded image;
wherein accepting the recorded image corresponds to a determination that the user is a human.

23. The computer-program product of claim 22, wherein determining whether a camera device is connected with the computer system comprises:
determining whether the camera device is capable of performing video recording when it is determined that a camera device is connected with the computer system; and
determining, via the user, whether to enable video recording using the camera device.

24. The computer-program product of claim 22, wherein the requested action to be performed comprises at least one gesture to be performed via a face, hands or other body parts of the user.

25. The computer-program product of claim 22, wherein requesting the user to perform an action comprises:
providing instructions from a server in communication with the computer system, to the user via the computer system, to request performance of the action; and
capturing a preview of an image of the user, and displaying the preview via a display device of the computer system.
